(19) United States
(12) Patent Application Publication
(10) Pub. No.: US 2006/0268867 A1
(43) Pub. Date: Nov. 30, 2006

(54) TCP/IP reception processing circuit and semiconductor integrated circuit implementing the same

(75) Inventors: Koji Hashimoto, Fukuoka (JP); Chisato Higuchi, Chofu (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/440,975

(22) Filed: May 25, 2006

(30) Foreign Application Priority Data
May 25, 2005 (JP) 2005-151893

(51) Int. Cl. H04L 12/56; H04J 3/16

(52) U.S. Cl. 370/389; 370/469

(57) ABSTRACT

A TCP/IP (Transmission Control Protocol/Internet Protocol) reception processing circuit for transferring a packet included in a frame and received from a lower layer to a memory accessible by an upper layer, includes a section that presumes a communication end point as a destination of the packet included in the frame and received from the lower layer and starts transfer of the packet to the communication end point presumed as the destination of the packet in parallel with specifying the communication end point as the destination of the packet, and a section that stops the transfer of the packet to the communication end point presumed as the destination of the packet and starting transfer of the packet to the communication end point specified as the destination of the packet in response to the communication end point specified as the destination of the packet if the communication end point presumed as the destination of the packet is unmatched with the communication end point specified as the destination of the packet, if the communication end point presumed as the destination of the packet is matched with the communication end point specified as the destination of the packet, the transfer of the packet to the communication end point presumed as the destination of the packet is continued.

### BACKGROUND OF THE INVENTION

1. Technical Field

The present invention relates to a transmission control protocol/internet protocol (TCP/IP) reception processing circuit for executing a receiving process of TCP/IP. Further, the invention relates to a semiconductor integrated circuit implementing such a TCP/IP reception processing circuit.

2. Related Art

In the present day, a layer model of a communication protocol called TCP/IP is widely used in Internet, local area network (LAN), and so on. FIG. 10 is a diagram showing a rough relationship between each layer of the TCP/IP layer model and each layer of open systems interconnection (OSI) reference model established by international organization for standardization (ISO).

Ethernet (registered trademark) as the network interface layer of the TCP/IP layer model, internet protocol version 4 (hereinafter simply referred to as IP) as the Internet layer of the TCP/IP layer model, and transmission control protocol (TCP) or user datagram protocol (UDP) as the transport layer of the TCP/IP layer model are widely used. Note that Ethernet (registered trademark) is defined in IEEE 802.3 and so on, IP is defined in RFC (Request For Comments) 791 and so on, TCP is defined in RFC 793, and UDP is defined in RFC 768 and so on.

Further, as a protocol for managing a network, address resolution protocol (ARP) and reverse address resolution protocol (RARP) corresponding to the Internet layer of the TCP/IP layer model, and internet control message protocol (ICMP) corresponding to the transport layer of the TCP/IP layer model are widely used. Note that ARP is defined in RFC 826 and so on, RARP is defined in RFC 903 and so on, and ICMP is defined in RFC 792 and so on.

FIG. 11 is a diagram showing a format of the Ethernet (registered trademark) frame (hereinafter simply referred to as frame). As shown in FIG. 11, the frame includes a header and a payload. Note that when the frame is actually sent on a network, preamble and frame check sequence containing a cyclic redundancy check (CRC) are added to the frame at the head and the foot thereof, respectively.

FIG. 12 is a diagram showing a format of an IP packet. As shown in FIG. 12, the IP packet includes an IP header and an IP payload. The IP packet is stored in the payload of the frame (See FIG. 11.).

FIG. 13 is a diagram showing a format of an ARP packet and a RARP packet. The ARP packet and the RARP packet are stored in the payload of the frame (See FIG. 11.).

FIG. 14 is a diagram showing a format of a TCP packet. As shown in FIG. 14, the TCP packet includes a TCP header and a TCP payload. The TCP packet is stored in the payload of the IP packet (See FIG. 12.).

FIG. 15 is a diagram showing a format of a UDP packet. As shown in FIG. 15, the UDP packet includes a UDP header and a UDP payload. The UDP packet is stored in the payload of the IP packet (See FIG. 12.).

FIG. 16 is a diagram showing a format of an ICMP packet. The ICMP packet is stored in the payload of the IP packet (See FIG. 12.).

It has been often the case with existing computers that the network interface layer is realized by a hardware circuit (hereinafter referred to as NIC (Network Interface Card)), and the Internet layer through the application layer are realized by software (programs). However, in the case in which the Internet layer through the application layer are realized by a CPU and the software (programs), a load for the CPU is problematically heavy. Therefore, in recent years, the load of the CPU is being lightened by using a TCP/IP reception processing circuit, which realizes the Internet layer and/or the transport layer with a hardware circuit.

As related art, JP-A-11-168451 (Page 1, FIG. 1) discloses a method of receiving data in a network node having a network adapter and a protocol stack with a plurality of layers characterized by including a step of transferring packet bytes forming an incoming data packet from a network medium to a memory, a step of calculating a code from the packet bytes forming a part of the incoming data packet when the packet bytes are sent from the network medium to the memory, a step of transferring the code to a code channel relating to the protocol stack, a step of receiving data extracted from a data packet in the first layer of the plurality of layers of the protocol stack, and a step of verifying the extracted data using a code from the code channel.

By the method, a checksum of TCP or the like can be calculated when a packet is transferred from a network medium to a memory.

Further, JP-A-6-78001 (Page 1, FIG. 1) discloses a method of sending a network packet received from a network by a network adapter in a computer system connected to the network and having a main storage device and the network adapter, including (a) a step of putting a header of the network packet in a first memory buffer in the main storage device by the network adapter, and (b) a step of putting data included in the network packet at the head of a second memory buffer.

By this method, the header and the data of the incoming packet can be separated and stored to separate memory buffers.

Incidentally, in general, the application program (e.g., a web browser program or a mail client program) executed in the application layer receives a packet from a communication end point (provided by an application programming interface (API) on an operating system (OS)). The communication end point is supplied with the packet by the OS. When the OS receives the packet from the NIC via a device driver (program), the OS judges whether or not the packet is addressed to an existing communication end point, and if the packet is addressed to an existing communication end point, the OS supplies the communication end point with the packet.

Note that the specification of the API in the communication end point of the TCP/IP in ITRON is described in “ITRON TCP/IP API Specification Ver. 1.00.01,” Embedded TCP/IP Technical Committee (edited by Hiroaki Takada), [online], May 19, 1998, ITRON Technical Committee, TRON Association, [searched on Apr. 13, 2005], Internet <URL: http://www.assoc.tron.org/spec/itron/tcpip-100j.pdf>.

FIG. 17 is a flowchart showing an example of an operation of an existing TCP/IP reception processing circuit in which the Internet layer and the transport layer is realized with a hardware circuit.

The existing TCP/IP reception processing circuit, upon reception of a frame from the network interface layer, firstly verifies (step S51) the frame using a CRC.

Subsequently, the existing TCP/IP reception processing circuit verifies (step S52) the IP packet using a header checksum of the IP (See FIG. 12.), and further, verifies the TCP packet or the UDP packet (step S53) using checksum (See FIGS. 14 and 15.) of the TCP or the UDP, respectively.

Further, the exiting TCP/IP reception processing circuit performs (step S54) a format analysis of the packets in parallel with the verification (step S52) of the IP packet and the verification (step S53) of the TCP packet or the UDP packet. This can be realized by separately providing a hardware circuit for performing the verification of the IP packet and the TCP packet or the UDP packet and a hardware circuit for performing the format analysis of the packets. Note that it can be thought that the parallel processing of the different processes as described above corresponds to “fork” and “join” in the software engineering field.

After finishing the verification of the IP packet (step S52), the verification of the TCP packet or the UDP packet (step S53), and the format analysis of the packets (step S54), the existing TCP/IP reception processing circuit performs (step S55) an identification of the communication end point.

And then, the existing TCP/IP reception processing circuit performs (step S56) DMA transfer of the packets to the identified communication end point. Thus, the packets in the frame received from the network interface layer are sent to the communication end point.

The communication end point is identified by a protocol (TCP or UDP), a source (self) IP address, a source (self) port number, a destination (counterpart) IP address, and a destination (counterpart) port number (hereinafter referred to as “communication end point identification information”). Here, one bit is necessary for distinguishing the TCP from the UDP, the source (self) IP address and the destination (counterpart) IP address have each 32-bit width, and the source (self) port number and the destination (counterpart) port number have each 16-bit width. Therefore, in the step S55 above, in order for identifying the communication end point, it is necessary to compare (pattern-match) 97 bits.

The identification of the communication end point is easy if a comparator with 97-bit width is implemented in the TCP/IP reception processing circuit. However, an amount of hardware of the 97-bit width comparator is significantly large, and the cost therefor is also high, therefore, it is difficult to implement such a comparator in the TCP/IP reception processing circuit. Accordingly, the TCP/IP reception processing circuit needs to repeatedly operate a comparator with smaller bit width, for example, to perform the identification of the communication end point, thus the identification of the communication end point takes long time.

It takes long time to identify the communication end point as described above, on the one hand, the transfer rate of the network interface layer has been improved and accordingly 100 BASE-TX, 1000 BASE-T and so on are being used in recent years, on the other. Therefore, it can occur that, while executing the identification of the communication end point of the frame already arrived spending long time, new frames arrive from the network interface layer one after another. In this case, there is caused no problem if a buffer memory with a significantly large capacity capable of storing a number of frames is implemented in the TCP/IP reception processing circuit, but an amount of hardware of the buffer memory with a significantly large capacity is significantly large, and the cost therefor is also high, therefore, it is difficult to implement such a buffer memory in the TCP/IP reception processing circuit. Therefore, lost (omission) of the frame occurs frequently in the TCP/IP reception processing circuit, thus the communication throughput is lowered in some cases.

### SUMMARY

In consideration of the above points, the invention has an advantage of providing a TCP/IP reception processing circuit capable of preventing degradation of the communication throughput while suppressing increase in the amount of hardware. Further, the invention also has an advantage of providing a semiconductor integrated circuit equipped with such a TCP/IP reception processing circuit.

A TCP/IP (Transmission Control Protocol/Internet Protocol) reception processing circuit according to an aspect of the invention is a TCP/IP reception processing circuit for transferring a packet included in a frame and received from a lower layer to a memory accessible by an upper layer, presuming a communication end point as a destination of the packet included in the frame and received from the lower layer and starting transfer of the packet to the communication end point presumed as the destination of the packet in parallel with specifying the communication end point as the destination of the packet, stopping the transfer of the packet to the communication end point presumed as the destination of the packet, and starting transfer of the packet to the communication end point specified as the destination of the packet if the communication end point specified as the destination of the packet and the communication end point presumed as the destination of the packet do not match with each other.

The TCP/IP reception processing circuit can be arranged to perform, in parallel with verification of an IP (Internet Protocol) packet using a header checksum in the IP packet included in the frame and received from the lower layer, verification of a TCP (Transmission Control Protocol) packet or a UDP (User Datagram Protocol) packet using a checksum of a TCP or a UDP in one of the TCP packet and the UDP packet in the IP packet, format analysis of the IP packet, the TCP packet, or the UDP packet, and specifying a communication end point as a destination of the TCP packet or the UDP packet, extraction of information necessary for presuming the communication end point as the destination of the TCP packet or the UDP packet from the frame, presumption of the communication end point as the destination of the packet, and commencement of transfer of the packet to the communication end point presumed as the destination of the packet, and to stop the transfer of the packet to the communication end point presumed as the destination of the packet and to start transfer of the packet to the communication end point specified as the destination of the packet if the communication end point specified as the destination of the packet and the communication end point presumed as the destination of the packet do not match with each other.

Further, it can also be arranged to specify the communication end point as the destination of the TCP packet or the UDP packet using distinction between the TCP packet and the UDP packet, a source IP address, a source port number, a destination IP address, and a destination port number in the IP packet included in the frame received from the lower layer, and to presume the communication end point as the destination of the TCP packet or the UDP packet using the distinction between the TCP packet and the UDP packet, a predetermined part of the source IP address, a predetermined part of the source port number, a predetermined part of the destination IP address, and a predetermined part of the destination port number in the IP packet included in the frame and received from the lower layer.

Further, the memory can include a communication end point information area including a plurality of packet storing areas each storing respective one of a plurality of packets addressed to a predetermined communication end point, and a plurality of descriptor tables linked by a first pointer provided to each of the plurality of descriptor tables, and each provided with a second pointer for designating respective one of the plurality of packet storing areas and packet write enable/disable information representing whether or not the packet can be written in the packet storing area designated by the second pointer, and it can be arranged to determine one of the plurality of descriptor tables designating the packet storing area to which the packet can be written using the first pointer and the packet write enable/disable information if the packet included in the frame and received from the lower layer is specified or presumed as a packet addressed to the predetermined communication end point, and

to transfer the packet included in the frame and received from the lower layer to the packet storing area designated by the second pointer in the descriptor table.

Further, each of the plurality of packet storing areas can include a header storing area for storing a header of the packet and a payload storing area for storing a payload of the packet, and the second pointer can include a third pointer for designating the header storing area and a fourth pointer for designating the payload storing area, and and it can be arranged to determine one of the plurality of descriptor tables designating the packet storing area to which the packet can be written using the first pointer and the packet write enable/disable information if the packet included in the frame and received from the lower layer is specified or presumed as a packet addressed to the predetermined communication end point, to transfer the header of the packet included in the frame and received from the lower layer to the header storing area designated by the third pointer in the descriptor table, and to transfer the payload of the packet included in the frame and received from the lower layer to the payload storing area designated by the fourth pointer in the descriptor table.

Further, the payload storing areas in the plurality of packet storing areas can be disposed in successive addresses in the memory.

Further, each of the plurality of descriptor tables can further include header storing area size information representing the size of the header which can be stored in the header storing area and payload storing area size information representing the size of the payload which can be stored in the payload storing area, and it can be arranged to determine one of the plurality of descriptor tables designating the packet storing area to which the packet can be written using the first pointer and the packet write enable/disable information if the packet included in the frame received from the lower layer is specified or presumed as a packet addressed to the predetermined communication end point, to transfer, if the size of the header of the packet included in the frame and received from the lower layer is greater than the size represented by the header storing area size information in the descriptor table, a part of the header of the packet included in the frame and received from the lower layer, which can be stored in the header storing area designated by the descriptor table, to the header storing area designated by the descriptor table, and to transfer, if the size of the payload of the packet included in the frame and received from the lower layer is greater than the size represented by the payload storing area size information in the descriptor table, a part of the payload of the packet included in the frame and received from the lower layer, which can be stored in the payload storing area designated by the descriptor table, to the payload storing area designated by the descriptor table.

Further, it can further include a backward counter in which an initial size of a logical data stream block of the predetermined communication end point can be set by the upper layer, and subtract a value corresponding to the size of the payload of the packet included in the frame and received from the lower layer from the backward counter if the packet included in the frame and received from the lower layer is specified or presumed as a packet addressed to the predetermined communication end point, and if the value of the counter becomes zero, it can output to the upper layer a control signal for notifying accordingly.

Further, the predetermined communication end point can be a communication end point of the TCP, and the memory can further include an RST packet storing area for storing an RST packet addressed to the predetermined communication end point, and an RST descriptor table having a pointer for designating the RST packet storing area, and it can be arranged to transfer the RST packet to the RST packet storing area designated by the pointer in the RST descriptor table if the packet included in the frame and received from the lower layer is specified or presumed as the RST packet addressed to the predetermined communication end point.

Further, it can include a forward counter in which an initial value of a sequence number of the predetermined communication end point can be set by the upper layer, and can be arranged to transfer the packet included in the frame and received from the lower layer to the memory and to increment the value of the forward counter if the packet included in the frame- and received from the lower layer is specified or presumed as a packet addressed to the predetermined communication end point and if the sequence number in a TCP header of the packet and the value of the forward counter match with each other.

Further, each of the plurality of descriptor tables can further include an analysis result storing area for storing an analysis result of the frame received from the lower layer or the packet included in the frame and received from the lower layer, and it can be arranged to determine one of the plurality of descriptor tables designating the packet storing area to which the packet can be written using the first pointer and the packet write enable/disable information if the packet included in the frame and received from the lower layer is specified or presumed as a packet addressed to the predetermined communication end point, and to transfer the packet included in the frame and received from the lower layer to the packet storing area designated by the second pointer in the descriptor table, and to write the analysis result of the frame received from the lower layer or the packet included in the frame and received from the lower layer to the analysis result storing area.

Further, the memory can include a plurality of communication end point information areas respectively corresponding to the plurality of communication end points, and it can be arranged to write the packet to the packet storing area designated by the descriptor table in the communication end point information area out of the plurality of communication end point information areas and corresponding to the communication end point specified or presumed as the destination of the packet if the packet included in the frame and received from the lower layer is specified or presumed as the packet addressed to either of the plurality of communication end points.

Further, the memory can further include a second communication end point information area for storing the frame if the protocol of the packet included in the frame and received from the lower layer is not a predetermined protocol, or storing the packet if the packet included in the frame and received from the lower layer is a packet addressed to none of the plurality of communication end points, and it can be arranged to transfer the frame if the protocol of the packet included in the frame and received from the lower layer is not a predetermined protocol, or the packet if the packet included in the frame and received from the lower layer is a packet addressed to none of the plurality of communication end points to the packet storing area designated by the descriptor table in the second communication end point information area if the protocol of the packet included in the frame and received from the lower layer is not a predetermined protocol, or the packet included in the frame and received from the lower layer is a packet addressed to none of the plurality of communication end points.

Further, a semiconductor integrated circuit according to another aspect of the invention is equipped with the TCP/IP reception processing circuit according to the above aspect of the invention.

### BRIEF DESCRIPTION OF THE DRAWINGS

The invention will now be described with reference to the accompanying drawings, wherein like numbers refer to like elements.

FIG. 1 is a block diagram showing a system using a circuit according to a first embodiment of the invention.

FIG. 2 is a diagram showing contents of the main memory 9 and the registers in the DMA control section 24 shown in FIG. 1.

FIG. 3 is a diagram showing a format of the descriptor table shown in FIG. 2.

FIG. 4 is a diagram showing a format of the communication end point condition setting table shown in FIG. 2.

FIGS. 5A and 5B are diagrams showing contents of the main memory shown in FIG. 1.

FIG. 6 is a diagram showing a format of the information stored in the communication end point presumption information storing section shown in FIG. 1.

FIG. 7 is a flowchart showing an operation of the TCP/IP reception processing circuit 5 shown in FIG. 1.

FIG. 8 is a block diagram showing a system using a circuit according to a second embodiment of the invention.

FIG. 9 is a flowchart showing an operation of the TCP/IP reception processing circuit 14 shown in FIG. 8.

FIG. 10 is a diagram showing a relationship between the OSI reference model and the TCP/IP layer model.

FIG. 11 is a diagram showing a format of the frame.

FIG. 12 is a diagram showing a format of the IP packet.

FIG. 13 is a diagram showing a format of the ARP packet and the RARP packet.

FIG. 14 is a diagram showing a format of the TCP packet.

FIG. 15 is a diagram showing a format of the UDP packet.

FIG. 16 is a diagram showing a format of the ICMP packet.

FIG. 17 is a flowchart showing an operation of an existing TCP/IP reception processing circuit.

### DESCRIPTION OF THE EMBODIMENTS

Hereinafter, embodiments of the present invention will be described with reference to the accompanying drawings. Note that like numbers refer to like elements.

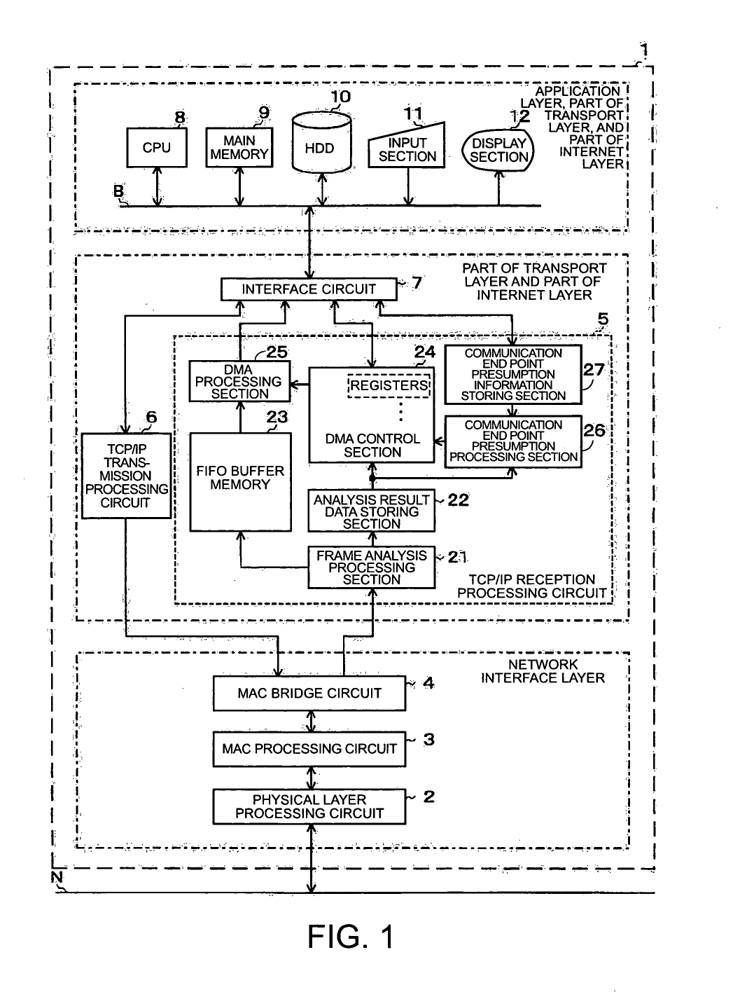

FIG. 1 is a block diagram schematically showing a computer using the TCP/IP (Transmission Control Protocol/Internet Protocol) reception processing circuit as a first embodiment of the invention. The computer 1 is provided with a physical layer processing circuit (PHY) 2 connected to a network N, an MAC (Media Access Control) processing circuit 3, an MAC bridge circuit 4, the TCP/IP reception processing circuit 5 as the first embodiment of the invention, a TCP/IP transmission processing circuit 6, an interface circuit 7, a CPU 8, a main memory 9, an HDD (Hard Disk Drive) 10, an input section 11, and a display section 12.

In the present embodiment, it is assumed that the network interface layer of the TCP/IP layer model is Ethernet (registered trademark), and that the physical layer processing circuit 2, the MAC processing circuit 3, and the MAC bridge circuit 4 serve as the network interface layer. The physical processing circuit 2 is connected to the network N, the MAC processing circuit 3 is connected to the physical processing circuit 2, and the MAC bridge circuit 4 is connected to the MAC processing circuit 3.

Further, it is assumed that the TCP/IP reception processing circuit 5, the TCP/IP transmission processing circuit 6, and the interface circuit 7 serve as a part of the Internet layer and a part of the transport layer. The TCP/IP reception processing circuit 5 and the TCP/IP transmission processing circuit 6 are each connected between the MAC bridge circuit 4 and the interface circuit 7.

Further, it is assumed that the CPU 8, the main memory 9, the HDD 10, the input section 11, and the display section 12 serve as a part of the Internet layer, a part of the transport layer, and the application layer of the TCP/IP layer model. For example, an OS (Operating System), an API (Application Programming Interface) program, a mail client program, a web browser program and so on are recorded in the HDD 10, and the CPU 8 executes these programs while using the main memory 9 as a working area. The CPU 8, the main memory 9, the HDD 10, the input section 11, and the display section 12 are connected via a bus B, and the bus B is connected to the interface circuit 7.

The TCP/IP reception processing circuit 5 is equipped with a frame analysis processing section 21 for performing analysis of the frame and so on, an analysis result data storing section 22 for storing the analysis result by the frame analysis processing section 21, a FIFO (First In First Out) buffer memory 23 for storing the packets and so on, a DMA (Direct Memory Access) control section 24, a DMA processing section 25 for performing DMA transfer of the packets and so on stored in the FIFO buffer memory 23 to the main memory 9 under control of the DMA control section 24, a communication end point presumption processing section 26 for presuming the communication end point as the destination of the packets, and a communication end point presumption information storing section 27 for storing communication end point presumption information used for presuming the communication end point as the destination of the packets. The DMA control section 24 includes a plurality of registers mapped in the I/O address space of the CPU 8. Further, the communication end point presumption information storing section 27 is mapped in the I/O address space of the CPU 8.

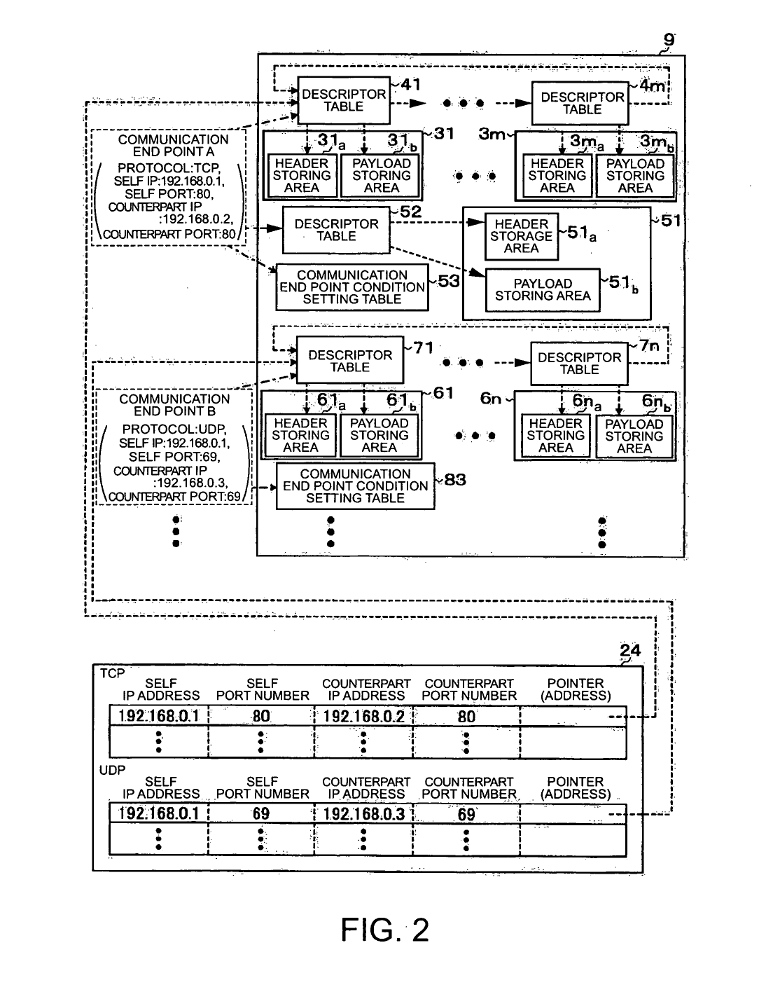

FIG. 2 is a diagram showing an example of the contents of the plurality of registers in the DMA control section 24 and the main memory 9.

When the API for establishing a communication end point is called in the application layer, a group of areas corresponding to the established communication end point are provided in the main memory 9 by the API. In FIG. 2, there are shown a first group of areas corresponding to a communication end point A (assuming here that the protocol is TCP (Transmission Control Protocol), self IP address is 192.168.0.1, self port number is 80, the counterpart IP address is 192.168.0.2, and the counterpart port number is 80) and a second group of areas corresponding to a communication end point B (assuming here that the protocol is UDP (User Datagram Protocol), self IP address is 192.168.0.1, self port number is 69, the counterpart IP address is 192.168.0.3, and the counterpart port number is 69).

The first group of areas includes a plurality of packet storing areas 31 through 3m for respectively storing the packets addressed to the communication end point A. The packet storing areas 31 through 3m include header storing areas 31ₐ through 3mₐ and payload storing areas 31_{b} through 3m_{b}, respectively. Further, the first group of areas further includes descriptor tables 41 through 4m respectively having pointers to the header storing areas 31ₐ through 3mₐ and the payload storing areas 31_{b} through 3m_{b}.

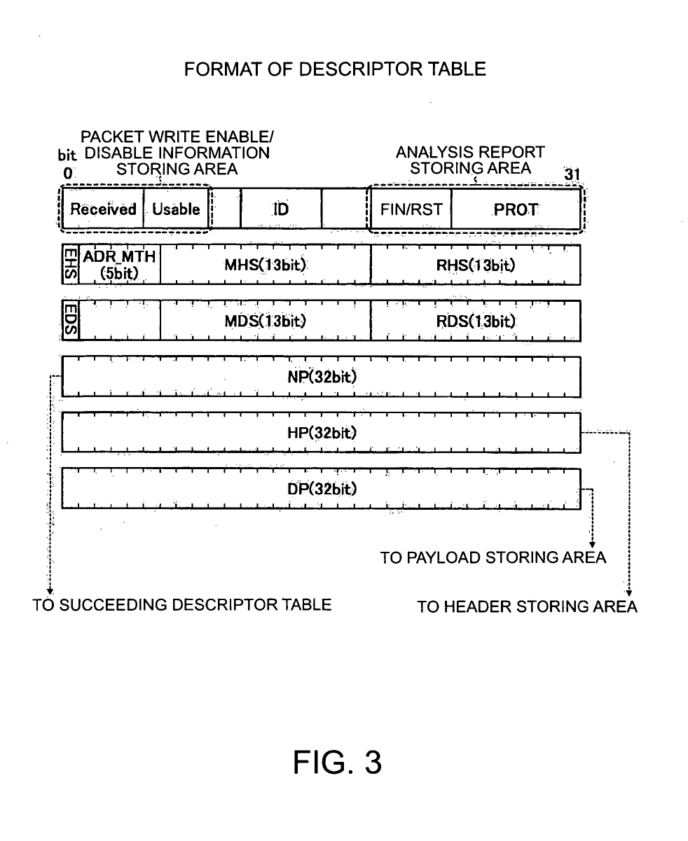

FIG. 3 is a diagram showing a format of the descriptor tables 41 through 4m. As shown in FIG. 3, the descriptor tables 41 through 4m are each composed of six words (It is assumed in the present embodiment that one word has 32-bit width.). The first word includes a packet write enable/disable information storing area for storing the information regarding whether or not the packet is allowed to be written to the packet storing area designated by the present descriptor table. The packet write enable/disable information storing area includes a RECEIVED field for storing information representing whether or not a packet has already been stored in the packet storing area designated by the present descriptor table and a USABLE field for storing information representing whether or not the packet storing area designated by the present descriptor table is usable.

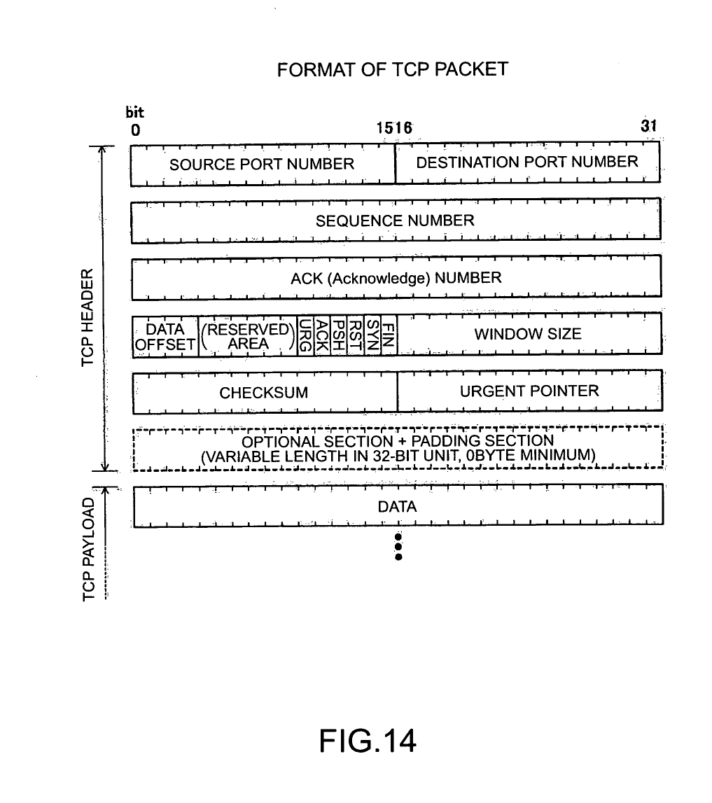

The first word of each of the descriptor table 41 through 4m further includes an analysis report storing area for storing a report of an analysis result of the packet stored in the packet storing area designated by the present descriptor table. The analysis report storing area includes an FIN/RST field for storing information representing whether or not a FIN flag or a RST flag (See FIG. 14.) in the TCP header is set and a PROT field for storing information representing the kind of the protocol (TCP here).

The second word of each of the descriptor tables 41 through 4m includes an MHS field (13-bit width) for storing information representing the maximum storable size of the header to the header storing area designated by the present descriptor table. The value of this field is set when the communication end point is established. Further, the second word of each of the descriptor tables 41 through 4m further includes an RHS field (13-bit width) for storing information representing the actual size of the header stored in the header storing area designated by the present descriptor table. Still further, the second word of each of the descriptor tables 41 through 4m further includes an EHS field for storing information representing occurrence of the error that the value of the RHS field is greater than the value of the MHS field.

The third word of each of the descriptor tables 41 through 4m includes an MDS field (13-bit width) for storing information representing the maximum storable size of the payload to the payload storing area designated by the present descriptor table. The value of this field is set when the communication end point is established. Further, the third word of each of the descriptor tables 41 through 4m further includes an RDS field (13-bit width) for storing information representing the actual size of the payload stored in the payload storing area designated by the present descriptor table. Still further, the third word of each of the descriptor tables 41 through 4m further includes an EDS field for storing information representing occurrence of the error that the value of the RDS field is greater than the value of the MDS field.

The fourth word of each of the descriptor tables 41 through 4m includes an NP field (32-bit width) for storing a pointer (address) designating the succeeding descriptor table. By the NP field, a plurality of descriptor tables is linked circularly (See FIG. 2.). Thus, the packet storing areas 31 through 3m can be used similarly to the FIFO buffer.

The fifth word of each of the descriptor tables 41 through 4m includes an HP field (32-bit width) for storing a pointer (address) designating the header storing area.

The sixth word of each of the descriptor tables 41 through 4m includes a DP field (32-bit width) for storing a pointer (address) designating the payload storing area.

Note that the API for establishing the communication end point can set the header storing areas 31ₐ through 3mₐ to have different sizes from the payload storing areas 31_{b} through 3m_{b}. Even if the header storing areas 31ₐ through 3mₐ and the payload storing areas 31_{b} through 3m_{b} are set to have different sizes from each other, the TCP/IP reception processing circuit 5 can detect the sizes of the header storing areas 31ₐ through 3mₐ and the payload storing areas 31_{b} through 3m_{b} because the sizes of the header storing areas 31ₐ through 3mₐ and the payload storing areas 31_{b} through 3m_{b} are respectively set to the MHS fields and the MDS fields of the descriptor tables 41 through 4m.

Referring to FIG. 2 again, the first group of areas further includes a packet storing area 51 for storing an RST packet (the packet with the RST flag (See FIG. 14.) in the TCP header set) for breaking the connection of the TCP. The packet storing area 51 includes a header storing area 51a and a payload storing area 5b. Further, the first group of areas further includes a descriptor table 52 for designating the header storing area 51a and the payload storing area 51b. The format of the descriptor table 52 is the same as the format of the descriptor tables 41 through 4m shown in FIG. 3. The reason why the packet storing area 51 for storing the RST packet is provided separately from other packet storing areas 31 through 3m is as follows. Namely, in the TCP, reception of the RST packet is regarded as reception of an instruction for breaking the session. Therefore, it is arranged that, even if the RST packet to the communication end point A is received when packets are stored all of the packet storing areas 31 through 3m, the received RST packet is unfailingly transferred to and stored in the main memory 9 to surely perform the process of breaking the connection of TCP in the application layer, thus avoiding the concern of causing a situation that the communication end point does not function until the session timeout resulting in significant harmful influence to the communication efficiency.

Further, the first group of areas further includes a communication end point condition setting table 53 for storing information regarding the communication end point A.

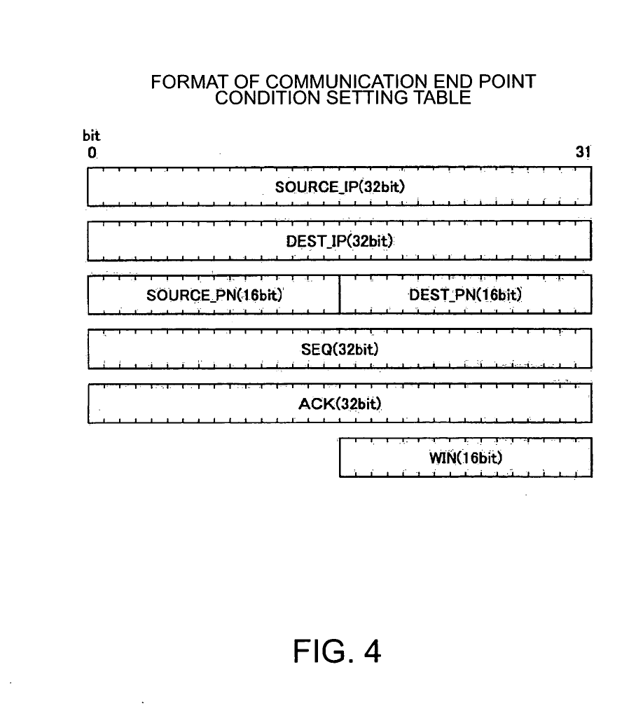

FIG. 4 is a diagram showing a format of the communication end point condition setting table 53. As shown in FIG. 4, the communication end point condition setting table 53 is composed of five and a half word. The first word includes a SOURCE_IP field (32-bit width) for storing the source (self IP address of the communication end point A.

The second word of the communication end point condition setting table 53 includes a DEST_IP field (32-bit width) for storing the destination (counterpart) IP address of the communication end point A.

The third word of the communication end point condition setting table 53 includes a SOURCE_PN field (16-bit width) for storing the source (self) port number of the communication end point A and a DEST_PN field (16-bit width) for storing the destination (counterpart) port number of the communication end point A.

The fourth word of the communication end point condition setting table 53 includes a SEQ field (32-bit width) for storing a sequence number of the communication end point A.

The fifth word of the communication end point condition setting table 53 includes an ACK field (32-bit width) for storing an acknowledge number of the communication end point A.

The last half word of the communication end point condition setting table 53 includes a WIN field (16-bit width) for storing the window size of the communication end point A.

Referring to FIG. 2 again, the second group of areas corresponding to the communication end point B includes a plurality of packet storing areas 61 through 6n for respectively storing the packets to the communication end point B. The packet storing areas 61 through 6n include header storing areas 61a through 6nₐ and payload storing areas 61_{b} through 6n_{b}, respectively. Further, the second group of areas further includes descriptor tables 71 through 7n respectively having pointers to the header storing areas 61a through 6na and the payload storing area 61b through 6nb, and a communication end point condition setting table 83 for storing information regarding the communication end point B.

The protocol of the communication end point B is the UDP, and accordingly, the RST packet to the communication end point B cannot exist. Therefor, the second group of areas does not include such areas for storing the RST packet as the packet storing area 51 or the descriptor table. 52 in the first group of areas explained above.

Further, since the protocol of the communication end point B is the UDP, the FIN packet as well as the RST packet to the communication end point B cannot exist. Therefore, although the descriptor tables 71 through 7n are almost the same as the descriptor tables 41 through 4m shown in FIG. 3, the FIN/RST field in the first word is unnecessary.

Further, since the protocol of the communication end point B is UDP, the sequence number, the acknowledge number, and the window size do not exist in the communication end point B. Therefore, it is enough for the communication end point condition setting table 83 in the second group of areas to have the three words (the source IP address, the destination IP address, the source port number, and the destination port number), namely the first through the third words of the communication end point condition setting table 53 shown in FIG. 4.

Meanwhile, the registers in the DMA control section 24 are divided into a first group register for the communication end point of the TCP and a second group register for communication end point of the UDP. Each of the first and the second group registers includes a first field for storing the source (self) IP address, a second field for storing the source (self) port number, a third field for storing the destination (counterpart) IP address, a fourth field for storing the destination (counterpart) port number, and a fifth field for storing the pointer (address) for designating one of a plurality of descriptor tables corresponding to a communication end point specified by the values of the first through the fourth fields.

As explained above, each of the registers in the DMA control section 24 is mapped in the I/O address space of the CPU 8, and can be accessed by the CPU 8 as an I/O device. And, when the API for establishing a communication end point is called in the application layer, the descriptor tables, the packet storing areas, and so on corresponding to the established communication end point are formed in the main memory 9 by the API, and at the same time, the source (self) IP address, the source (self port number, the destination (counterpart) IP address, and the destination (counterpart) port number for specifying the established communication end point, and the pointer (address) for designating one (the forehead one, here) of the plurality of descriptor tables corresponding to the established communication end point are written in the register in the DMA control section 24 by the API.

Note that the computer 1 might possibly receive a packet having a protocol (e.g., ICMP (Internet Control Message Protocol)) of the transport layer other than the TCP or the UDP, or a packet having a protocol (e.g., ARP (Address Resolution Protocol), RARP (Reverse Address Resolution Protocol), and IP version six) of the network layer other than the IP version four. To cope with such a case, a group of areas (hereinafter referred to as “junk buffer”) for storing the packet having the protocol of the transport layer other than the TCP or the UDP or the packet having the protocol of the network layer other than the IP version four are previously prepared in the main memory 9. The junk buffer includes a plurality of packet storing areas for storing the packet having the protocol of the transport layer other than the TCP or the UDP or the packet having the protocol of the network layer other than the IP version four and a plurality of descriptor tables each having a pointer to respective one of the plurality of packet storing areas.

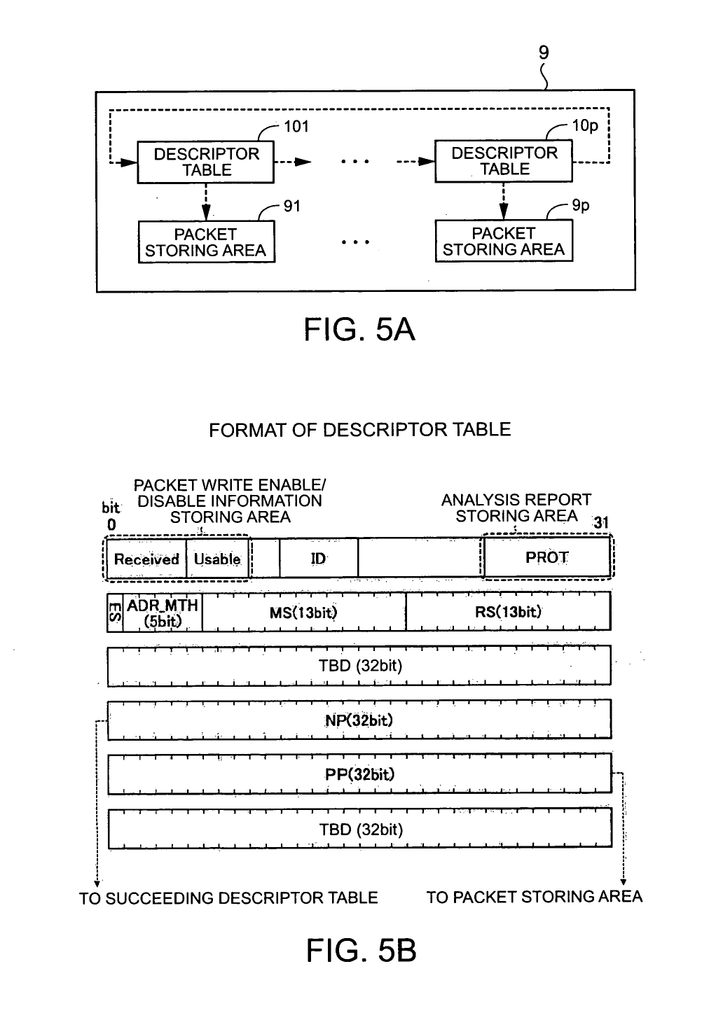

FIG. 5A is a diagram showing the junk buffer in the main memory 9. Here, the junk buffer includes a plurality of packet storing areas 91 through 9p and a plurality of descriptor tables 101 through 10p.

FIG. 5B is a diagram showing a format of the descriptor tables 101 through 10p. As shown in FIG. 5B, the descriptor tables 101 through 10p are each composed of six words. The first word includes a packet write enable/disable information storing area for storing the information regarding whether or not the packet is allowed to be written to the packet storing area designated by the present descriptor table. Here, the packet write enable/disable information storing area includes a RECEIVED field for storing information representing whether or not a packet has already been stored in the packet storing area designated by the present descriptor table and a USABLE field for storing information representing whether or not the packet storing area designated by the present descriptor table is usable.

The first word of each of the descriptor table 101 through 10p further includes an analysis report storing area for storing a report of an analysis result of the packet stored in the packet storing area designated by the present descriptor table. Here, the analysis report storing area includes a PROT field for storing information representing the kind of the protocol.

The second word of each of the descriptor tables 101 through 10p includes an MS field (13-bit width) for storing information representing the maximum storable size of the packet in the packet storing area designated by the present descriptor table. The value of this field is set in initialization. Further, the second word of each of the descriptor tables 101 through 10p further includes an RS field (13-bit width) for storing information representing the actual size of the packet stored in the packet storing area designated by the present descriptor table. Still further, the second word of each of the descriptor tables 101 through 10p further includes an ES field for storing information representing occurrence of the error that the value of the RS field is greater than the value of the MS field.

The third word of each of the descriptor tables 101 through 10p is not in use.

The fourth word of each of the descriptor tables 101 through 10p includes the NP field (32-bit width) for storing a pointer (address) designating the succeeding descriptor table. By the NP field, a plurality of descriptor tables is linked circularly (See FIG. 5A.). Thus, the packet storing areas 91 through 9p can be used similarly to the FIFO buffer.

The fifth word of each of the descriptor tables 101 through 10p includes an PP field (32-bit width) for storing a pointer (address) designating the packet storing area.

The sixth word of each of the descriptor tables 101 through 10p is not in use.

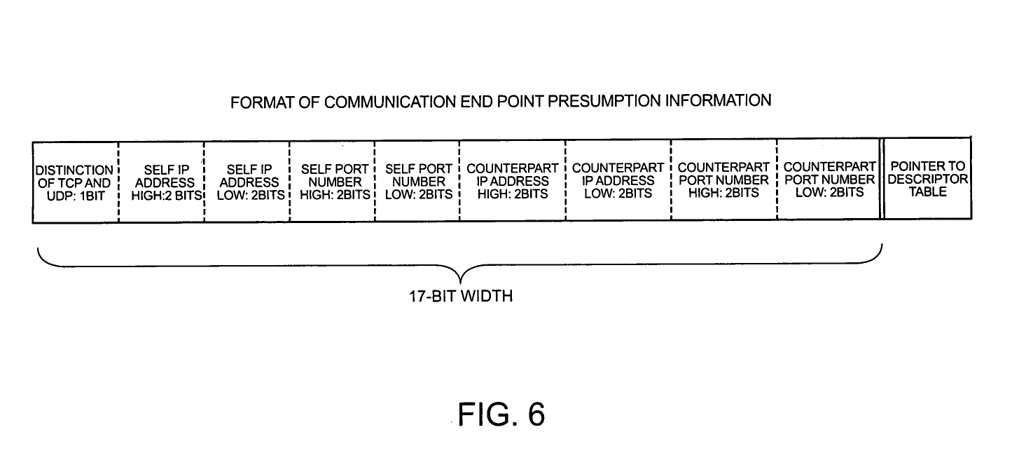

FIG. 6 is a diagram showing a format of the communication end point presumption information stored in the communication end point presumption information storing section 27. The communication end point presumption information is information used for presuming a communication end point.

As explained above, the communication end point is identified by a protocol (TCP or UDP), a source (self) IP address, a source (self) port number, a destination (counterpart) IP address, and a destination (counterpart) port number (hereinafter referred to as “communication end point identification information”). One bit is necessary for distinguishing the TCP from the UDP, the source (self) IP address and the destination (counterpart) IP address have each 32-bit width, and the source (self) port number and the destination (counterpart) port number have each 16-bit width. Therefore, in order for specifying the communication end point, comparison (pattern matching) of 97-bit width data is necessary, which requires a long period of time.

Consequently, when the API for establishing a communication end point is called in the application layer, the communication end point presumption information for presuming the established communication end point is written into the communication end point presumption information storing area 27 by the API. In the present embodiment, the communication end point presumption information includes totally 17 bits, namely one bit of TCP/UDP distinction, the high (MSB (Most Significant Bit) side) two bits of the source (self) IP address, the low (LSB (Least Significant Bit) side) two bits of the source (self) IP address, the high (MSB side) two bits of the source (self) port number, the low (LSB side) two bits of the source (self) port number, the high (MSB side) two bits of the destination (counterpart) IP address, the low (LSB side) two bits of the destination (counterpart) IP address, the high (MSB side) two bits of the destination (counterpart) port number, the low (LSB side) two bits of the destination (counterpart) port number, as shown in FIG. 6. Namely, the communication end point can be presumed by comparing (pattern-matching) only 17-bit width data. The comparison (pattern matching) of 17-bit width data can be executed in a relatively short period of time.

In the communication end point presumption information storing section 27, the pointer (address) for designating one (the forehead one, here) of the plurality of descriptor tables corresponding to the communication end point presumed by the communication end point presumption information is stored correspondingly thereto.

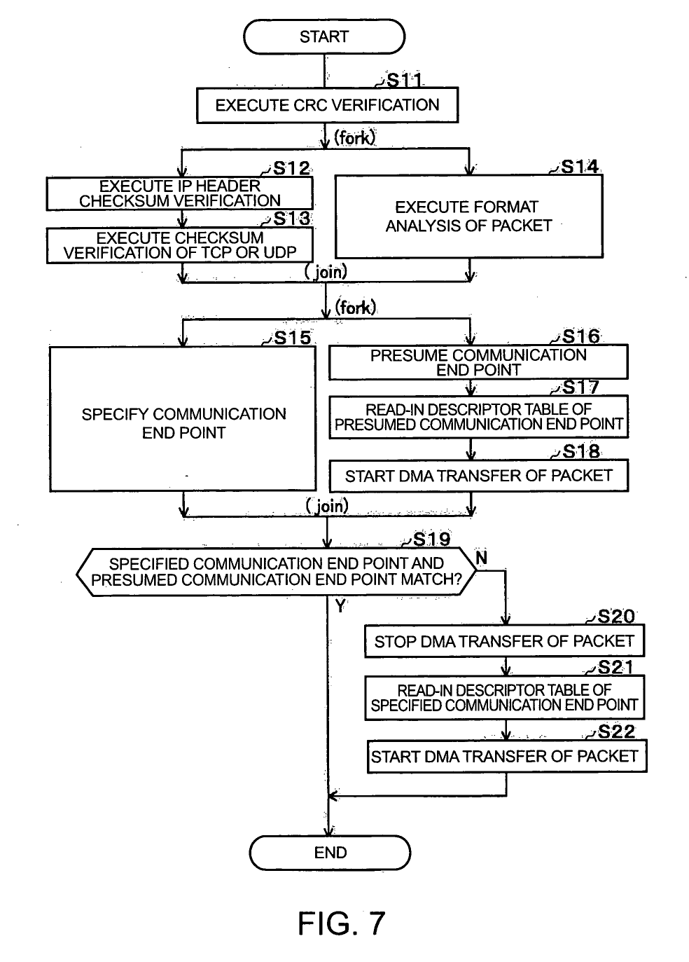

Hereinafter, the operation of the TCP/IP reception processing circuit 5 will be explained. FIG. 7 is a flowchart showing the operation of the TCP/IP reception processing circuit 5. The TCP/IP reception processing circuit 5 begins the process shown in FIG. 7 in response to reception of a frame from the MAC bridge circuit 4 in the network interface layer.

Firstly, a frame analysis processing section 21 in the TCP/IP reception processing circuit 5 performs verification of the frame (step S11) using a CRC (Cyclic Redundancy Check) in the frame check sequence (Frame Check Sequence) added to the frame at the foot thereof received from the MAC bridge circuit 4. Note that, if the CRC error is detected, the frame analysis processing section 21 rejects the frame.

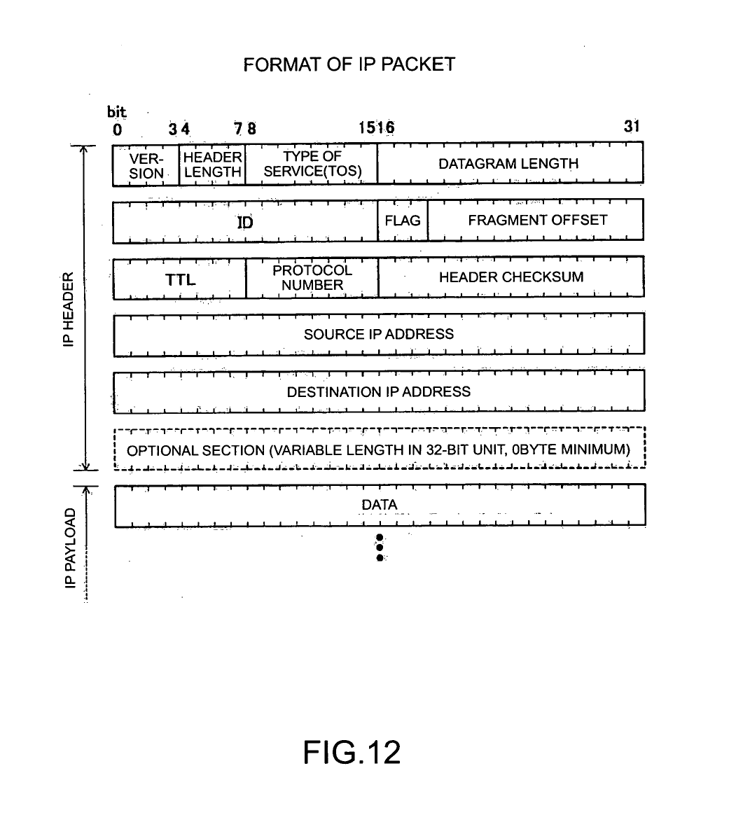

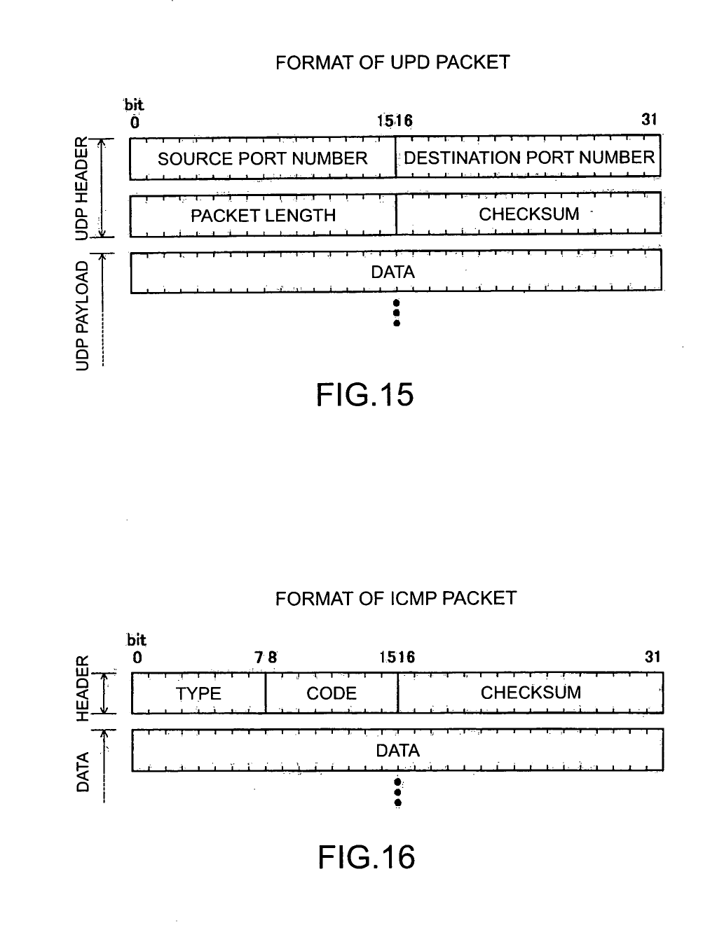

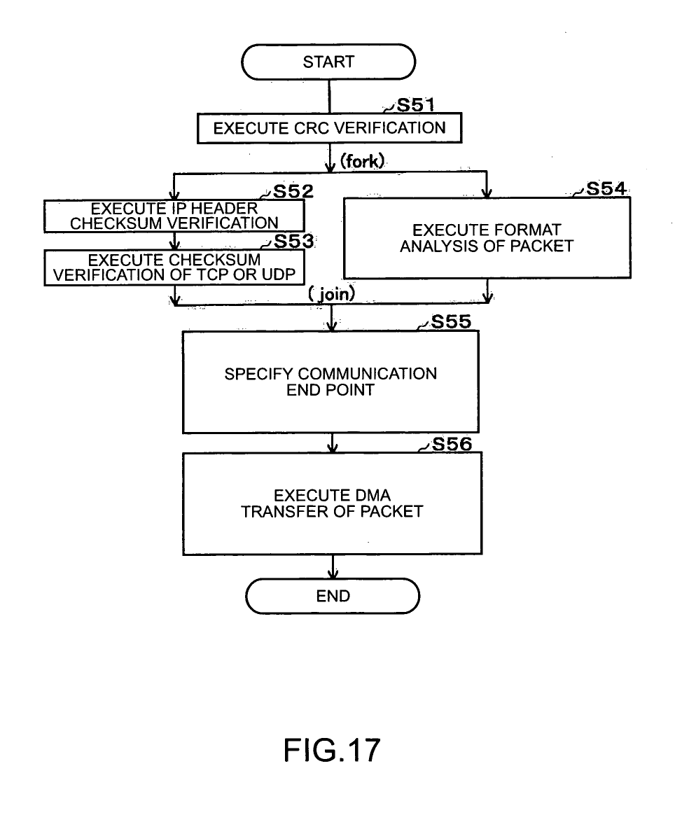

Subsequently, the frame analysis processing section 21 performs verification of the IP packet (step S12) using the header checksum (See FIG. 12.) of the IP and verification of the TCP packet or the UDP packet (step S13) using the checksum (See FIGS. 14 and 15.) of the TCP or the UDP, and also performs, in parallel therewith, format analysis (step S14) of the packet stored in the payload of the frame. This can be realized by separately providing the frame analysis processing section 21 with a hardware circuit for performing the verification of the IP packet and the TCP packet or the UDP packet, and a hardware circuit for performing the format analysis of the packets. Note that it can be thought that the parallel processing of the different processes as described above corresponds to “fork” and “join” in the software engineering field.

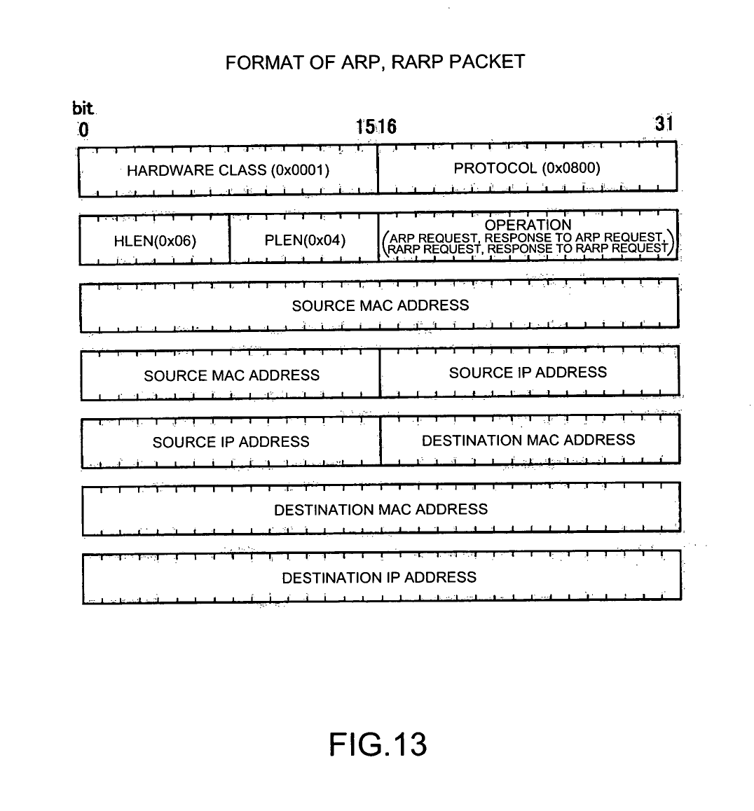

The format analysis of the packet executed by the frame analysis processing section 21 includes an examination whether or not the protocol of the packet stored in the payload of the frame is a predetermined protocol (the protocol of the Internet layer is IP and the protocol of the transport layer is TCP, the protocol of the Internet layer is IP and the protocol of the transport layer is UDP, the protocol of the Internet layer is IP and the protocol of the transport layer is ICMP, the protocol of the Internet layer is ARP, or the protocol of the Internet layer is RARP, in the present embodiment). Whether or not it is the predetermined protocol can be judged by whether or not the packet corresponds to the formats shown in FIGS. 12 through 16.

The analysis result written in the analysis result data storing section 22 by the frame analysis processing section 21 includes the protocol (the protocol of the Internet layer is IP and the protocol of the transport layer is TCP, the protocol of the Internet layer is IP and the protocol of the transport layer is UDP, the protocol of the Internet layer is IP and the protocol of the transport layer is ICMP, the protocol of the Internet layer is ARP, or the protocol of the Internet layer is RARP, in the present embodiment) and the size of the packet. Further, in the case in which, in the packet stored in the payload of the frame, the protocol of the Internet layer is IP and the protocol of the transport layer is TCP, or the protocol of the Internet layer is IP and the protocol of the transport layer is UDP, the analysis result written in the analysis result data storing section 22 by the frame analysis processing section 21 further includes the size of the TCP header or the UDP header, the size of the TCP payload or the UDP payload, and information for specifying a communication end point (the source (self) IP address, the source (self) port number, the destination (counterpart) IP address, and the destination (counterpart) port number). Note that the source (self) IP address and the destination (counterpart) IP address are stored in the IP header (See FIG. 12.), and the source (self) port number and the destination (counterpart) port number are storied in the TCP header (See FIG. 14.) or the UDP header (See FIG. 15.).

When the frame analysis processing section 21 judges that the protocol of the packet stored in the payload of the frame is not the predetermined protocol (e.g., the case in which the protocol of the network layer of the packet stored in the payload of the frame is IP version six, or the case in which the protocol of the network layer of the packet stored in the payload of the frame is IP but the protocol of the transport layer is a protocol other than TCP, UDP, or ICMP), the frame analysis processing section 21 writes the frame directly to the FIFO buffer memory 23, and the DMA control section 24 and the DMA processing section 25 transfer the frame to the junk buffer in the main memory 9. In the frame transferred to the junk buffer, the Internet layer and the transport layer are processed by the CPU and the software (program).

Further, when the protocol of the packet stored in the payload of the frame is ARP or RARP, the frame analysis processing section 21 writes the ARP packet or the RARP packet in the FIFO buffer memory 23.

Further, in the case in which the protocol of the packet stored in the payload of the frame is IP, the frame analysis processing section 21 writes the packet (the TCP packet, the UDP packet or the ICMP packet in the present embodiment) stored in the payload of the IP packet in the FIFO buffer memory 23.

Note that it can be arranged that the frame analysis processing section 21 is provided with a plurality of automatic forward counters mapped in the I/O address space of the CPU 8, and the API writes an initial value of the sequence number of the communication end point of the TCP in either one of the automatic forward counters when the communication end point of the TCP is established. And, when the frame analysis processing section 21 receives the frame containing the packet to the communication end point of the TCP from the MAC bridge circuit 4, if the sequence number (See FIG. 12.) in the packet and the value of the automatic forward counter are equal, the frame analysis processing section 21 can write the packet to the FIFO buffer memory 23 and at the same time increment the automatic forward counter, and if the sequence number and the value of the automatic forward counter are not equal, the frame analysis processing section 21 can reject the packet. In the TCP, the packet arrival ordering and the basic communication path safety are obtained by verifying concordance of the sequence number. In general, one logical data stream is often composed of a plurality of incoming packets, and by providing the automatic forward counter as described above, it becomes possible without using the software to judge whether or not the packet reception is acceptable.

After the processes (steps S12 through S14) by the frame analysis processing section 21 are finished, the DMA control section 24 specifies the communication end point (step S15), and the communication end point presumption processing section 26 presumes the communication end point (step S16). Note that it can be thought that the parallel processing of the different processes as described above corresponds to “fork” and “join” in the software engineering field.

The DMA control section 24 looks up the protocol in the analysis result stored in the analysis result data storing section 22, and if the packet or the like (the packet or the frame) stored in the FIFO buffer memory 23 is the TCP packet or the UDP packet, the DMA control section 24 further looks up the information (the source (self) IP address, the source (self) port number, the destination (counterpart) IP address, and the destination (counterpart) port number) for specifying the communication end point in the analysis result stored in the analysis result data storing section 22 to check whether or not the TCP packet of the UDP packet stored in the FIFO buffer memory 23 is addressed to either of the communication end points. Specifically, the information for specifying the established communication end point is stored in the registers in the DMA control section 24 as described above (See FIG. 2.), the DMA control section 24 can specify the communication end point as the destination of the TCP packet or the UDP packet stored in the FIFO buffer memory 23 by comparing (pattern-matching) the information in the analysis result stored in the analysis result data storing section 22 for specifying the communication end point with the contents of the registers. Alternatively, the DMA control section 24 can check whether or not the TCP packet or the UDP packet stored in the FIFO buffer memory 23 is addressed to either of the communication end points by comparing the information in the analysis result stored in the analysis result data storing section 22 for specifying the communication end point with the contents of the communication end point condition setting-table 53 in the main memory 9. The comparison (pattern matching) is a comparison (pattern matching) of 97-bit width data, which requires a long period of time.

Meanwhile the communication end point presumption processing section 26 presumes the communication end point (step S16) as the destination of the TCP packet of the UDP packet stored in the FIFO buffer memory 23 by comparing (pattern-matching) totally 17 bits, namely one bit of TCP/UDP distinction, the high (MSB side) two bits of the source (self) IP address, the low (LSB side) two bits of the source (self) IP address, the high (MSB side) two bits of the source (self) port number, the low (LSB side) two bits of the source (self) port number, the high (MSB side) two bits of the destination (counterpart) IP address, the low (LSB side) two bits of the destination (counterpart) IP address, the high (MSB side) two bits of the destination (counterpart) port number, and the low (LSB side) two bits of the destination (counterpart) port number, with the communication end point presumption information (See FIG. 6.) stored in the communication end point presumption information storing section 27. The pointer (See FIG. 6.) to the descriptor table as the presumption result is sent to the DMA control section 24.

A part of the hardware of the DMA control section 24 is performing the specifying operation (step S15), while another part of the hardware of the DMA control section 24 reads in (step S17), from the main memory 9, the descriptor table (See FIG. 2.) corresponding to the communication end point presumed as the destination of the packet, and capable of storing the packet, using the pointer sent from the communication end-point presumption processing section 26. And, still another part of the hardware of the DMA control section 24 controls the DMA processing section 25 (step S18) so as to start the DMA transfer of the packet stored in the FIFO buffer memory 23 to the packet storing area (See FIG. 2.) designated by the descriptor table read in in the step S17.

Specifically, if the packet stored in the FIFO buffer memory 23 is presumed to be the TCP packet addressed to the communication end point A, the DMA control section 24 controls the DMA processing section 25 so as to start transferring the TCP packet stored in the FIFO buffer memory 23 to either of the packet storing areas 31 through 3m (See FIG. 2.). Note that which one of the packet storing areas 31 through 3m is selected as the destination of the DMA transfer can be determined by sequentially looking up the packet write enable/disable information storing areas (See FIG. 3.) in the descriptor tables 41 through 4m from the pointer (address) in the communication end point presumption information (See FIG. 6.) to find the packet storing area to which the packet can be written. Further, the amount of the DMA transfer (the data size of the DMA transfer) can be determined by looking up the TCP header size and the TCP payload size stored in the analysis result data storing section 22. Note that if the size of the header or the payload of the TCP packet stored in the FIFO buffer memory 23 exceeds the size (which can be detected by the MHS field or the MDS field in FIG. 3) of the destination header storing area or the destination payload storing area, the DMA control section 24 can be arranged to perform the DMA transfer of only a part of the header or the payload of the packet which can be stored in the destination header storing area or the destination payload storing area, and not to perform the DMA transfer of the rest of the header or the payload of the packet which is the excess to the size of the destination header storing area or the destination payload storing area.

Similarly, if the packet stored in the FIFO buffer memory 23 is presumed to be the UDP packet addressed to the communication end point B, the DMA control section 24 controls the DMA processing section 25 so as to start transferring the UDP packet stored in the FIFO buffer memory 23 to either of the packet storing areas 61 through 6n (See FIG. 2.). Note that which one of the packet storing areas 61 through 6n is selected as the destination of the DMA transfer can be determined by sequentially looking up the packet write enable/disable information storing areas (See FIG. 3.) in the descriptor tables 71 through 7n from the pointer (address) in the register to find the packet storing area to which the packet can be written. Further, the amount of the DMA transfer (the data size of the DMA transfer) can be determined by looking up the UDP header size and the UDP payload size stored in the analysis result data storing section 22. Note that if the size of the header or the payload of the UDP packet stored in the FIFO buffer memory 23 exceeds the size (which can be detected by the MHS field or the MDS field in FIG. 3) of the destination header storing area or the destination payload storing area, the DMA control section 24 can be arranged to perform the DMA transfer of only a part of the header or the payload of the packet which can be stored in the destination header storing area or the destination payload storing area, and not to perform the DMA transfer of the rest of the header or the payload of the packet which is the excess to the size of the destination header storing area or the destination payload storing area.

After the process (step S15) for specifying the communication end point, as well as the presumption of the communication end point, the process for reading in the descriptor table, and the commencement of the DMA transfer (steps S16 through S18) are finished, the DMA control section 24 checks whether or not the communication end point specified in the step S15 matches with the communication end point presumed in the step S16. And, if the communication end point specified in the step S15 matches with the communication end point presumed in the step S16, the DMA control section 24 terminates the process, and the DMA processing section 25 continues to perform the DMA transfer started in the step S18. If, however, the communication end point specified in the step S15 does not match with the communication end point presumed in the step S16, the DMA control section 24 transfers the process to the step S20 (step S19).

If the communication end point specified in the step S15 does not match with the communication end point presumed in the step S16, the DMA control section 24 controls the DMA processing section 25 so as to stop the DMA transfer started in the step S18 (step S20).

Subsequently, the DMA control section 24 reads in, from the main memory 9, the descriptor table (See FIG. 2.) corresponding to the communication end point specified as the destination of the packet, and capable of storing the packet (step S21). And then, the DMA control section 24 controls the DMA processing section 25 (step S22) so as to start the DMA transfer of the packet stored in the FIFO buffer memory 23 to the packet storing area (See FIG. 2.) designated by the descriptor table read in in the step S21, thus terminating the process.

Note that it can be arranged that the DMA control section 24 is provided with a plurality of automatic backward counters mapped in the I/O address space of the CPU 8, and the API writes an initial size of the logical data stream block (which can be a window buffer size) of the communication end point in either of the automatic backward counters when the communication end point is established. And, the amount of the DMA transfer can be subtracted from the value of the backward counter corresponding to the communication end point every time the DMA control section 24 performs, in the step S22, the DMA transfer of the payload of the TCP packet or the UDP packet stored in the FIFO buffer memory 23 to the payload storing area of the communication end point as the destination of the TCP packet or the UDP packet stored in the FIFO buffer memory 23. And, by arranging that the DMA control section 24 does not output a packet reception notification control signal to the CPU 8 until the backward counter value becomes zero, and outputs the packet reception notification control signal when the backward counter becomes zero, the application layer can handle a fixed length logical data stream composed of a plurality of incoming packets in a lump, thus reduction (e.g., reduction of the number of times of task switching or of interrupt generation) of software overhead can be achieved. Further, the DMA control section 24 can be arranged not to perform the DMA transfer of the excess in the payload to the value of the backward counter.

As explained above, according to the present embodiment, while a part of the hardware of the DMA control section 24 is specifying the communication end point as the destination of the packet, the communication end point presumption processing section 26 presumes the communication end point as the destination of the packet, and another part of the hardware of the DMA control section 24 can start the DMA transfer of the packet to the packet storing area corresponding to the presumed communication end point. The communication end point presumption processing section 26 can be realized using, for example, a comparator of 17-bit width. As described above, the commencement of the DMA transfer of the packet can be made earlier while suppressing increase in the amount of hardware, thus the communication throughput can be prevented from being lowered. Further, if the communication end point specified as the destination of the packet does not match with the communication end point presumed as the destination of the packet, the DMA transfer of the packet to the communication end point presumed as the destination of the packet is stopped and the DMA transfer of the packet to the communication end point specified as the destination of the packet can be started. Therefore, even if the presumption of the communication end point is wrong, the packet can be delivered to the communication end point, which is the true destination of the packet.

Note that, although in the present embodiment, the communication end point presumption information includes totally 17 bits, namely one bit of TCP/UDP distinction, the high (MSB side) two bits of the source (self) IP address, the low (LSB side) two bits of the source (self) IP address, the high (MSB side) two bits of the source (self port number, the low (LSB side) two bits of the source (self) port number, the high (MSB side) two bits of the destination (counterpart) IP address, the low (LSB side) two bits of the destination (counterpart) IP address, the high (MSB side) two bits of the destination (counterpart) port number, the low (LSB side) two bits of the destination (counterpart) port number, it can be arranged to include more bits or less bits. If the communication end point presumption information is arranged to include more bits, the provability that the presumed communication end point matches with the specified communication end point is enhanced while the load of the process (See the step S16.) for presuming the communication end point increases. On the contrary, if the communication end point presumption information is arranged to include less bits, the load of the process (See the step S16.) decreases while the provability that the presumed communication end point matches with the specified communication end point is lowered. Further, the communication end point presumption information can be arranged to include another part of the source (self) IP address, another part of the source (self) port number, another part of the destination (counterpart) IP address, and another part of the destination (counterpart) port number.

Still further, according to the present embodiment, by linking the descriptor tables, it can be simplified that the TCP/IP reception processing circuit 5 transfers the packets addressed to the communication end point of the TCP or the UDP to the packet storing areas in the main memory 9, thus the application layer can easily handle the logical data stream block defined by the number of the incoming packets.

Further, according to the present embodiment, the header and the payload of the packet addressed to the communication end point of the TCP or the UDP can be transferred to the header storing area and the payload storing area provided in the main memory 9. Thus, in the case in which a plurality of packets addressed to the same communication end point exists, the application layer can freely utilize the payloads only without looking up the headers. In this case, by disposing the plurality of payload storing areas in successive addresses, the application layer can easily access the plurality of payloads in serial order.

Further, in the present embodiment, if the size of the header or the payload of the packet addressed to the communication end point of the TCP or the UDP exceeds the size of the destination header storing area or the destination payload storing area, the DMA transfer of the excess of the header or the payload of the packet to the size of the destination header storing area or the destination payload storing area is not performed. Therefore, even if a third party supposedly send an incorrect packet to the computer 1, and the incorrect packet matches with the setting conditions of the communication end point of the TCP or the UDP, the DMA transfer of the excess of the header of the payload of the incorrect packet to the size of the destination header storing area or the destination payload storing area is not performed, and accordingly there is no possibility that the OS, the API, or a working area of an application program is overwritten with the incorrect packet. Thus, cracking or the like by the third party can be avoided.

Note that, although in the present embodiment, Ethernet (registered trademark) is used as the network interface layer, others can also be used therefor. Further, various objects such as HTTP (Hyper Text Transfer Protocol) can be used as the application layer.

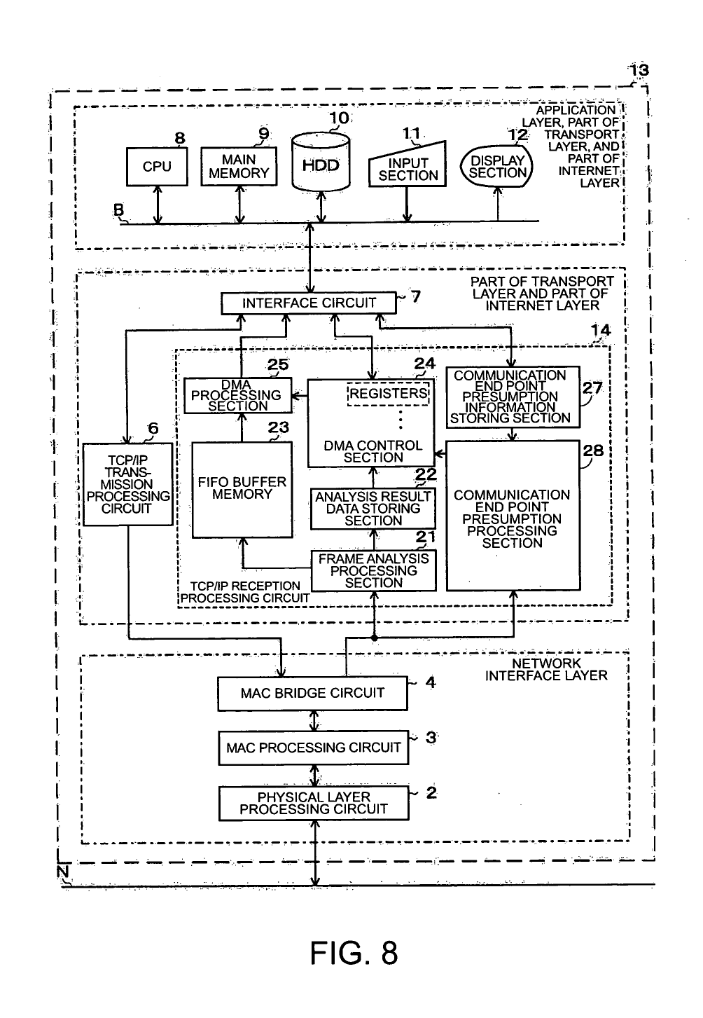

A second embodiment of the invention will hereinafter be described. FIG. 8 is a block diagram schematically showing a computer using the TCP/IP reception processing circuit as a second embodiment of the invention. The computer 13 is provided with the physical layer processing circuit 2 connected to the network N, the MAC processing circuit 3, the MAC bridge circuit 4, the TCP/IP transmission processing circuit 6, the interface circuit 7, the CPU 8, the main memory 9, the HDD 10, the input section 11, the display section 12, and the TCP/IP reception processing circuit 14 as the second embodiment of the invention.

In the present embodiment, it is assumed that the TCP/IP transmission processing circuit 6, the interface circuit 7, and the TCP/IP reception processing circuit 14 serve as a part of the Internet layer and a part of the transport layer. The TCP/IP transmission processing circuit 6 and the TCP/IP reception processing circuit 14 are each connected between the MAC bridge circuit 4 and the interface circuit 7.

The TCP/IP reception processing circuit 14 is provided with the frame analysis processing section 21, the analysis result data storing section 22, the FIFO buffer memory 23, the DMA control section 24, the DMA processing section 25, the communication end point presumption information storing section 27, and a communication end point presumption processing section 28 for presuming the communication end point as the destination of the packet.

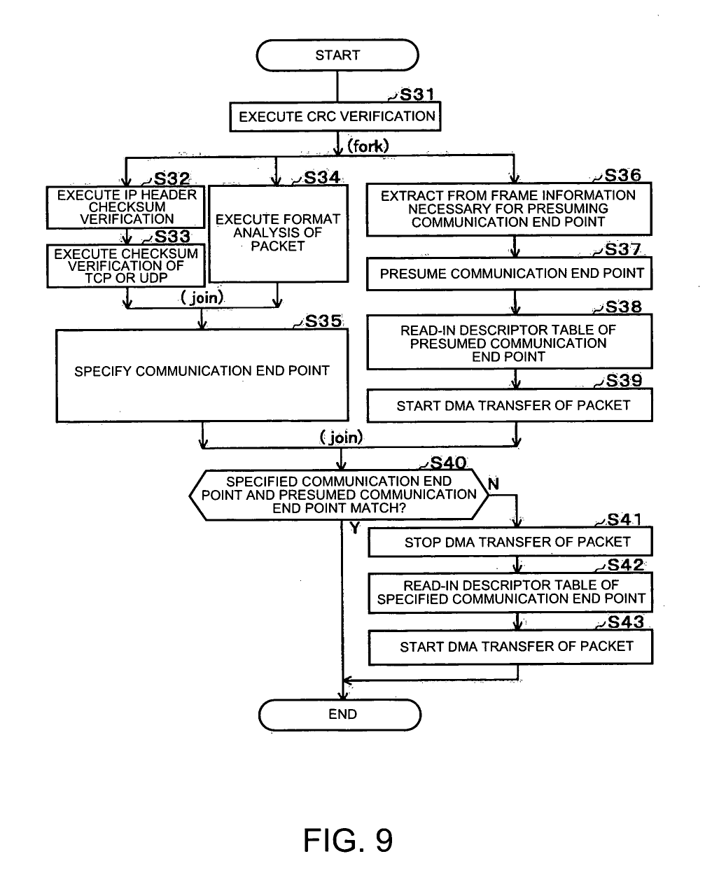

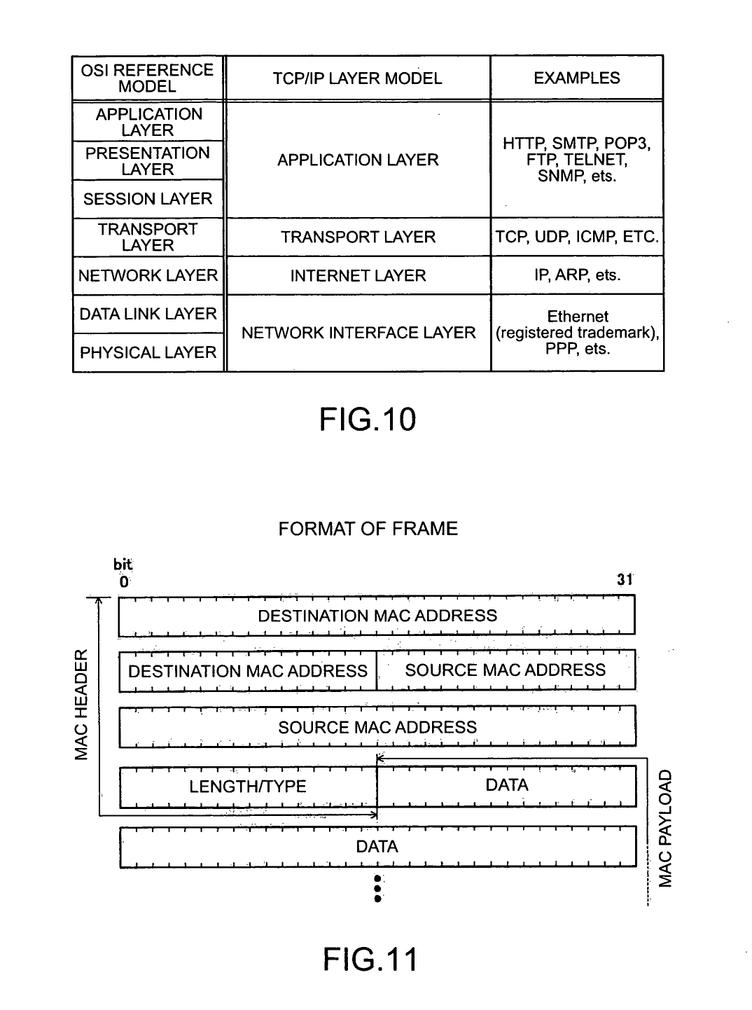

Hereinafter, the operation of the TCP/IP reception processing circuit 14 will be explained. FIG. 9 is a flowchart showing the operation of the TCP/IP reception processing circuit 14. The TCP/IP reception processing circuit 14 begins the process shown in FIG. 9 in response to reception of a frame from the MAC bridge circuit 4 in the network interface layer.

Firstly, the frame analysis processing section 21 in the TCP/IP reception processing circuit 14 performs verification of the frame (step S31) using a CRC in the frame check sequence added to the frame at the foot thereof received from the MAC bridge circuit 4. Note that, if the CRC error is detected, the frame analysis processing section 21 rejects the frame.

Subsequently, the frame analysis processing section 21 performs verification of the IP packet (step S32) using the header checksum (See FIG. 12.) of the IP and verification of the TCP packet or the UDP packet (step S33) using the checksum (See FIGS. 14 and 15.) of the TCP or the UDP, and also performs, in parallel therewith, format analysis (step S34) of the packet stored in the payload of the frame. This can be realized by separately providing the frame analysis processing section 21 with a hardware circuit for performing the verification of the IP packet and the TCP packet or the UDP packet, and a hardware circuit for performing the format analysis of the packets. Note that it can be thought that the parallel processing of the different processes as described above corresponds to “fork” and “join” in the software engineering field.

After the processes (steps S32 through S34) of the frame analysis processing section 21 is finished, the DMA control section 24 specifies the communication end-point (step S35).

Meanwhile, the frame from the MAC bridge circuit 4 of the network interface layer is also input to the communication end point presumption processing section 28, and the communication end point presumption processing section 28 extracts information necessary for presuming the communication end point (step S36) in parallel with the processes (step S32 through S34) of the frame analysis processing section 21 and the process (step S35) of the DMA control section 24. The information extracted from the frame by the communication end point presumption processing section 28 in the present embodiment includes distinction of TCP/UDP (one bit), the high (MSB side) two bits of the source (self) IP address, the low (LSB side) two bits of the source (self) IP address, the high (MSB side) two bits of the source (self) port number, the low (LSB side) two bits of the source (self) port number, the high (MSB side) two bits of the destination (counterpart) IP address, the low (LSB side) two bits of the destination (counterpart) IP address, the high (MSB side) two bits of the destination (counterpart) port number, the low (LSB side) two bits of the destination (counterpart) port number. Note that it can be thought that the parallel processing of the different processes as described above corresponds to “fork” and “join” in the software engineering field.

Subsequently, the communication end point presumption processing section 28 presumes the communication end point as the destination of the TCP packet or the UDP packet stored in the FIFO buffer memory 23 (step S37) by comparing (pattern matching) the information extracted from the frame in the step S36 with the communication end point presumption information (See FIG. 6.) stored in the communication end point presumption information storing section 27. The pointer (See FIG. 6.) to the descriptor table as the presumption result is sent to the DMA control section 24.

A part of the hardware of the DMA control section 24 is performing the specifying operation (step S35), while another part of the hardware of the DMA control section 24 reads in (step S38), from the main memory 9, the descriptor table (See FIG. 2.) corresponding to the communication end point presumed as the destination of the packet, and capable of storing the packet, using the pointer sent from the communication end point presumption processing section 28. And, still another part of the hardware of the DMA control section 24 controls the DMA processing section 25 (step S39) so as to start the DMA transfer of the packet stored in the FIFO buffer memory 23 to the packet storing area (See FIG. 2.) designated by the descriptor table read in in the step S38.

After the verification of the IP packet (step S32) using the header checksum of the IP, the verification of the TCP packet or the UDP packet (step S33) using the checksum of the TCP or the UDP, the format analysis of the packet (step S34), the specifying process of the communication end point_(step S35), the extracting process of the information necessary for presuming the communication end point from the frame (step S36), the presumption of the communication end point (step S37), the reading in process of the descriptor table (step S38), and the commencement of the DMA transfer (step S39) are finished, the DMA control section 24 checks whether or not the communication end point specified in the step S35 matches with the communication end point presumed in the step S37. And, if the communication end point specified in the step S35 matches with the communication end point presumed in the step S37, the DMA control section 24 terminates the process, and the DMA processing section 25 continues to perform the DMA transfer started in the step S39. If, however, the communication end point specified in the step S35 does not match with the communication end point presumed in the step S37, the DMA control section 24 transfers the process to the step S41 (step S40).

If the communication end point specified in the step S35 does not match with the communication end point presumed in the step S37, the DMA control section 24 controls the DMA processing section 25 so as to stop the DMA transfer started in the step S39 (step S41).

Subsequently, the DMA control section 24 reads in, from the main memory 9, the descriptor table (See FIG. 2.) corresponding to the communication end point specified as the destination of the packet, and capable of storing the packet (step S42). And then, the DMA control section 24 controls the DMA processing section 25 (step S43) so as to start the DMA transfer of the packet stored in the FIFO buffer memory 23 to the packet storing area (See FIG. 2.) designated by the descriptor table read in in the step S42, thus terminating the process.

As described above, according to the present embodiment, while the frame analysis processing section 21 is performing the verification of the IP packet using the header checksum of the IP, the verification of the TCP packet or the UDP packet using the checksum of the TCP or the UDP, and the format analysis of the packet, and a part of the hardware of the DMA control section 24 is performing the process of specifying the communication end point as the destination of the packet, the communication end point presumption processing section 28 can extract from the frame the information necessary for presuming the communication end point and then presume the communication end point as the destination of the packet, and another part of the hardware of the DMA control section 24 can start the DMA transfer of the packet to the packet storing area corresponding to the presumed communication end point. As described above, the commencement of the DMA transfer of the packet can be made earlier while suppressing increase in the amount of hardware, thus the communication throughput can be prevented from being lowered. Further, if the communication end point specified as the destination of the packet does not match with the communication end point presumed as the destination of the packet, the DMA transfer of the packet to the communication end point presumed as the destination of the packet is stopped, and the DMA transfer of the packet to the communication end point specified as the destination of the packet can be started. Therefore, even if the presumption of the communication end point is wrong, the packet can be delivered to the communication end point, which is the true destination of the packet.

The invention can be applied to the TCP/IP reception processing circuit. The TCP/IP reception processing circuit can be utilized for a personal computer, a cellular phone, a PDA, home electric appliances (e.g., a television, and a refrigerator), and so on.

The entire disclosure of Japanese Patent Application No. 2005-151893, filed May 25, 2005 is expressly incorporated by reference herein.

What is claimed is:

1. A Transmission Control Protocol/Internet Protocol (TCP/IP) reception processing circuit for transferring a packet included in a frame and received from a lower layer to a memory accessible by an upper layer, comprising:
a section that presumes a communication end point as a destination of the packet included in the frame and received from the lower layer and starts transfer of the packet to the communication end point presumed as the destination of the packet in parallel with specifying the communication end point as the destination of the packet; and
a section that stops the transfer of the packet to the communication end point presumed as the destination of the packet and starts transfer of the packet to the communication end point specified as the destination of the packet in response to the communication end point specified as the destination of the packet if the communication end point presumed as the destination of the packet is unmatched with the communication end point specified as the destination of the packet,
if the communication end point presumed as the destination of the packet is matched with the communication end point specified as the destination of the packet, the transfer of the packet to the communication end point presumed as the destination of the packet is continued.

2. The TCP/IP reception processing circuit according to claim 1, further comprising:
a section that performs, in parallel with verification of an IP (Internet Protocol) packet using a header checksum in the IP packet included in the frame and received from the lower layer, verification of one of a TCP (Transmission Control Protocol) packet and a UDP (User Datagram Protocol) packet using a checksum of one of a TCP and a UDP in one of the TCP packet and the UDP packet in the IP packet, format analysis of one of the IP packet, the TCP packet, and the UDP packet, and specifies a communication end point as a destination of one of the TCP packet and the UDP packet, extraction of information necessary for presuming the communication end point as the destination of one of the TCP packet and the UDP packet from the frame, presumption of the communication end point as the destination of the packet, and commencement of transfer of the packet to the communication end point presumed as the destination of the packet; and
a section that stops the transfer of the packet to the communication end point presumed as the destination of the packet and starts transfer of the packet to the communication end point specified as the destination of the packet in response to the communication end point specified as the destination of the packet if the communication end point presumed as the destination of the packet is unmatched with the communication end point specified as the destination of the packet,
if the communication end point presumed as the destination of the packet is matched with the communication end point specified as the destination of the packet, the transfer of the packet to the communication end point presumed as the destination of the packet is continued.

3. The TCP/IP reception processing circuit according to claim 1, further comprising:
a section that specifies the communication end point as the destination of one of the TCP packet and the UDP packet using distinction between the TCP packet and the UDP packet, a source IP address, a source port number, a destination IP address, and a destination port number in the IP packet included in the frame and received from the lower layer; and
a section that presumes the communication end point as the destination of one of the TCP packet and the UDP packet using the distinction between the TCP packet and the UDP packet, a predetermined part of the source IP address, a predetermined part of the source port number, a predetermined part of the destination IP address, and a predetermined part of the destination port number in the IP packet included in the frame and received from the lower layer.

4. The TCP/IP reception processing circuit according to claim 1, wherein the memory has a communication end point information area including a plurality of packet storing areas each storing respective one of a plurality of packets addressed to a predetermined communication end point, and a plurality of descriptor tables linked by a first pointer provided to each of the plurality of descriptor tables, and each provided with a second pointer for designating respective one of the plurality of packet storing areas and packet write enable/disable information representing whether or not the packet can be written in the packet storing area designated by the second pointer, further comprising:
a section that determines one of the plurality of descriptor tables designating the packet storing area to which the packet is written using the first pointer and the packet write enable/disable information in response to the packet included in the frame and received from the lower layer being one of specified and presumed as a packet addressed to the predetermined communication end point; and
a section that transfers the packet included in the frame and received from the lower layer to the packet storing area designated by the second pointer in the descriptor table.

5. The TCP/IP reception processing circuit according to claim 4, wherein each of the plurality of packet storing areas includes a header storing area for storing a header of the packet and a payload storing area for storing a payload of the packet, and the second pointer includes a third pointer for designating the header storing area and a fourth pointer for designating the payload storing area, further comprising:
a section that determines one of the plurality of descriptor tables designating the packet storing area to which the packet is written using the first pointer and the packet write enable/disable information in response to the packet included in the frame and received from the lower layer being one of specified and presumed as a packet addressed to the predetermined communication end point;
a section that transfers the header of the packet included in the frame received from the lower layer to the header storing area designated by the third pointer in the descriptor table; and
a section that transfers the payload of the packet included in the frame and received from the lower layer to the payload storing area designated by the fourth pointer in the descriptor table.

6. The TCP/IP reception processing circuit according to claim 5, wherein the payload storing areas in the plurality of packet storing areas are disposed in successive addresses in the memory.

7. The TCP/IP reception processing circuit according to claim 5, wherein each of the plurality of descriptor tables further includes header storing area size information representing the size of the header which is stored in the header storing area and payload storing area size information representing the size of the payload which can be stored in the payload storing area, further comprising:
a section that determines one of the plurality of descriptor tables designating the packet storing area to which the packet can be written using the first pointer and the packet write enable/disable information in response to the packet included in the frame and received from the lower layer being one of specified and presumed as a packet addressed to the predetermined communication end point;
a section that transfers, in response to the size of the header of the packet included in the frame and received from the lower layer being greater than the size represented by the header storing area size information in the descriptor table, a part of the header of the packet included in the frame and received from the lower layer, which is stored in the header storing area designated by the descriptor table, to the header storing area designated by the descriptor table; and
a section that transfers, in response to the size of the payload of the packet included in the frame and received from the lower layer being greater than the size represented by the payload storing area size information in the descriptor table, a part of the payload of the packet included in the frame and received from the lower layer, which is stored in the payload storing area designated by the descriptor table, to the payload storing area designated by the descriptor table.

8. The TCP/IP reception processing circuit according to claim 1, further comprising:
a backward counter in which an initial size of a logical data stream block of the predetermined communication end point can be set by the upper layer; and
a section that subtracts a value corresponding to the size of the payload of the packet included in the frame and received from the lower layer from the backward counter in response to the packet included in the frame and received from the lower layer being one of specified and presumed as a packet addressed to the predetermined communication end point, and in response to the value of the counter becoming zero, outputting to the upper layer a control signal for notifying accordingly.

9. The TCP/IP reception processing circuit according to claim 1, wherein the predetermined communication end point is a communication end point of the TCP, and the memory further includes an RST packet storing area for storing an RST packet addressed to the predetermined communication end point, and an RST descriptor table having a pointer for designating the RST packet storing area, further comprising:
a section that transfers the RST packet to the RST packet storing area designated by the pointer in the RST descriptor table in response to the packet included in the frame and received from the lower layer being one of specified and presumed as the RST packet addressed to the predetermined communication end point.

10. The TCP/IP reception processing circuit according to claim 1, further comprising:
a forward counter in which an initial value of a sequence number of the predetermined communication end point is set by the upper layer; and
a section that transfers the packet included in the frame and received from the lower layer to the memory and incrementing the value of the forward counter in response to the packet included in the frame and received from the lower layer being one of specified and presumed as a packet addressed to the predetermined communication end point and in response to the sequence-number in a TCP-header of the packet and the value of the forward counter matching with each other.

11. The TCP/IP reception processing circuit according to claim 1, wherein each of the plurality of descriptor tables further includes an analysis result storing area for storing an analysis result of one of the frame received from the lower layer and the packet included in the frame and received from the lower layer, further comprising:
a section that determines one of the plurality of descriptor tables designating the packet storing area to which the packet can be written using the first pointer and the packet write enable/disable information in response to the packet included in the frame and received from the lower layer being one of specified and presumed as a packet addressed to the predetermined communication end point; and
a section that transfers the packet included in the frame and received from the lower layer to the packet storing area designated by the second pointer in the descriptor table, and writing the analysis result of one of the frame received from the lower layer and the packet included in the frame and received from the lower layer to the analysis result storing area.

12. The TCP/IP reception processing circuit according to claim 1, wherein the memory includes a plurality of communication end point information areas respectively corresponding to the plurality of communication end points, further comprising:
a section that writes the packet to the packet storing area designated by the descriptor table in the communication end point information area out of the plurality of communication end point information areas and corresponding to the communication end point one of specified and presumed as the destination of the packet in response to the packet included in the frame and received from the lower layer is one of specified and presumed as the packet addressed to either of the plurality of communication end points.

13. The TCP/IP reception processing circuit according to claim 12, wherein the memory further includes a second communication end point information area for one of storing the frame in response to the protocol of the packet included in the frame and received from the lower layer not being a predetermined protocol, and storing the packet in response to the packet included in the frame and received from the lower layer being a packet addressed to none of the plurality of communication end points, further comprising:
a section that transfers one of the frame in response to the protocol of the packet included in the frame and received from the lower layer not being a predetermined protocol, and the packet in response to the packet included in the frame and received from the lower layer being a packet addressed to none of the plurality of communication end points to the packet storing area designated by the descriptor table in the second communication end point information area in response to one of the protocol of the packet included in the frame and received from the lower layer not being a predetermined protocol, and the packet included in the frame and received from the lower layer being a packet addressed to none of the plurality of communication end points.

14. A semiconductor integrated circuit equipped with the TCP/IP reception processing circuit according to claim 1.
